(19) United States
(12) Patent Application Publication
(10) Pub. No.: US 2012/0135256 A1
(43) Pub. Date: May 31, 2012

(54) Process Of Manufacturing Film Containing EVOH

(76) Inventors: Kevin M. Donovan, Pittsford, NY (US); David Liestman, Walworth, NY (US); Rajan Verghese, Pittsford, NY (US); Eric Thomas Gohr, Midwest City, OK (US); Rich F. Bray, Lagrange, GA (US); Justin T. Ford, Lagrange, GA (US)

(21) Appl. No.: 13/320,675

(22) PCT Filed: May 20, 2010
(86) PCT No.: PCT/US2010/035634

§ 371 Date: Feb. 21, 2012

Related U.S. Application Data
(60) Provisional application No. 61/184,121, filed on Jun. 4, 2009.

(51) Int. Cl. B32B 27/30; B29C 47/06

(52) U.S. Cl. 428/515; 264/173.17; 264/37.3; 428/500

(57) ABSTRACT

This disclosure relates to a process of manufacturing polymeric film, the process comprises (a) co-extruding (i) a first polymeric composition having a non-organic cavitating agent, (ii) a second polymeric composition having EVOH to form a multilayer sheet; and (b) orienting the co-extruded sheet in MD, TD or both, wherein the first polymeric composition and/or the second polymeric composition comprises recycled polymeric composition having EVOH and the non-organic cavitating agent.

### CROSS-REFERENCE TO RELATED APPLICATIONS

This application claims priority from U.S. Provisional Application Ser. No. 61/184,121, filed Jun. 4, 2009, the contents of which are incorporated by reference in their entirety.

### FIELD OF THE INVENTION

This disclosure relates to a process of manufacturing film containing ethylene vinyl alcohol copolymers (EVOHs). In particular, the present process comprises recycling EVOH containing material produced by in-line trim and/or reclaimed film material.

### BACKGROUND OF THE INVENTION

Polymeric films are useful for packaging or labeling applications. Polymeric films useful for packaging or labeling contain one or more polymeric layers made by extruding or co-extruding polymer resins to form a polymeric sheet, which is subjected to further process steps such as, orientation along the machine direction (MDO) or transverse direction (TDO) or both. For certain applications, at least one layer of a film is cavitated with cavitating agent(s) suitable for its intended applications. The rough edges of the oriented film including tapes of the oriented film oriented by using the tenter process are normally trimmed in-line or off-line and recycled back to the extrusion process. Film waste generated during orientation and/or post orientation process, or rejected for any quality reasons is also normally ground up, repelletized through a separate process, and recycled back into the extrusion process.

Cavitated films containing EVOH are particularly useful for packaging or labeling owing to the functionality offered by the hydroxyl group of the EVOH copolymer. However, it is difficult to recycle EVOH containing films that are cavitated using polybutylene terephthalate (PBT) as cavitating agent. The films produced with recycling trimmed edges of the EVOH containing films that are cavitated using PBT tend to split and it is difficult to maintain gauge on specification due to the degradation of the recycled material. Without a recycling step, the film manufacturing process has unacceptable low efficiency and the cost of the film product is high.

There is a need to develop a high efficiency process of manufacturing cavitated film containing EVOH which comprises recycling trimmed edges and repelletized waste of the EVOH containing film.

### SUMMARY OF THE INVENTION

In some embodiments, this disclosure relates to a process of manufacturing polymeric film, the process comprising:
a) co-extruding:
   i) a first polymeric composition having a non-organic cavitating agent;
   ii) a second polymeric composition having EVOH to form a multilayer sheet; and
b) orienting the co-extruded sheet in MD, TD or both,
   wherein the first polymeric composition and/or the second polymeric composition comprises recycled polymeric composition having EVOH and the non-organic cavitating agent.

In other embodiment, the recycled polymeric composition is produced by trimming edge(s) of the oriented film of step (b) or reclaimed film material(s) having EVOH and the non-organic cavitating agent.

### DETAIL DESCRIPTION OF THE INVENTION

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the disclosure will refer to any one or more of the appended claims, including their equivalents, and elements or limitations that are equivalent to those that are recited. Any reference to the “invention” may refer to one or more, but not necessarily all, of the inventions defined by the claims.

As used herein, the term “monomer” is a small molecule that may become chemically bonded to other monomers to form a polymer. Examples of monomers include olefinic monomers, such as, ethylene, propylene, butylenes, 1-hexene, styrene, and 1-octene.

As used herein, the term “polymer” refers to the product of a polymerization reaction, and is inclusive of homopolymers, copolymers, terpolymers, etc.

As used herein, unless specified otherwise, the term “copolymer(s)” refers to polymers formed by the polymerization of at least two different monomers. For example, the term “copolymer” includes the copolymerization reaction product of propylene and an alpha-olefin (α-olefin), such as ethylene. However, the term “copolymer” is also inclusive of, for example, the copolymerization of a mixture of more than two monomers, such as, ethylene-propylene-butene.

As used herein, weight percent (“wt. %”), unless noted otherwise, means a percent by weight of a particular component based on the total weight of the mixture containing the component. For example, if a mixture or blend contains three grams of compound A and one gram of compound B, then the compound A comprises 75 wt. % of the mixture and the compound B comprises 25 wt. %. As used herein, parts per million (ppm), unless noted otherwise, means parts per million by weight.

### Cavitated Layer and Cavitating Agent

The cavitated layer of the multilayered film of this disclosure comprises a polymer and at least one non-organic cavitating agent. Preferably, the cavitated layer comprises at least one of polypropylene, polypropylene and high density polyethylene (“HDPE”).

The term “non-organic cavitating agent” as used herein means a cavitating agent containing less than 10 wt. % organic matter. The amount of organic matter in a cavitating agent is measured by measuring the weight loss (without accounting of water loss) of ten grams of the cavitating agent after 24 hours' air burning (250° C. and air flowrate of 10 ml/min) in percentage.

Preferably, the non-organic cavitating agent of this disclosure has less than 5 wt. %, and more preferably less than 1 wt. % organic matter.

Examples of a suitable cavitating agent include at least one of iron oxide, carbon black, aluminum, titanium dioxide, calcium carbonate, glass spheres, calcium-magnesium carbonates, dolomite, silicates, barium sulphate, carbon black, slate powder, pearl white, silica, hydrated alumina, kaolin, diatomite, mica, zeolite and talcum. In some embodiments, the cavitating agent has a particle size of from about 0.5 to about 15 microns. In a preferred embodiment, the cavitated layer has a cavitating agent concentration in the range of 10 to 70 wt. %.

The cavitated layer may further comprise one or more additives. Such additives for the cavitated layer include, but are not limited to, hydrocarbon resin(s), hydrocarbon wax(es), opacifying, or coloring agent(s) and slip additive(s).

### EVOH Layer

The second polymeric composition comprises EVOH. EVOH refers to ethylene vinyl alcohol copolymers which are well known to exhibit good oxygen barrier properties. Such ethylene vinyl alcohol copolymers have been described in many patents including U.S. Pat. Nos. 3,975,463 and 4,468,427, which are both incorporated herein by reference thereto. The high barrier layer preferably includes from at least about 55% by weight, preferably at least about 80% by weight, more preferably at least about 90% by weight, of EVOH copolymer containing from about at least 48 mol. % of ethylene comonomer. Commercially available EVOH that can be used to prepare the high barrier layer of the present invention include EVAL™ G156B, G176, F104 or L101 which can be obtained from EVALCA.

### Orientation

The extruded sheet may be uniaxially or biaxially oriented. Orientation in the direction of extrusion is known as machine direction orientation. Orientation perpendicular to the direction of extrusion is known as transverse direction orientation. Orientation may be accomplished by stretching or pulling a film first in the MD, optionally followed by the TD. Orientation may be sequential or simultaneous, depending upon the desired film features.

In some embodiments, the sheet is stretched 3 to 7 times its original size, in the machine direction, followed by stretching 5 to 10 times its original size in the transverse direction in a tenter. The film is then in-line or off-line trimmed to remove off-specification portion, such as, side edge(s). The film is then wound onto a reel.

The films of this disclosure may be oriented by blown with controlling parameters such as take up and blow up ratio. Cast films may be oriented in the MD direction by take up speed, and in the TD through use of tenter equipment. Blown films or cast films may also be oriented by tenter-frame orientation subsequent to the film extrusion process, in one or both directions. Typical commercial orientation processes are biaxially oriented polypropylene (BOPP) tenter process and LISIM technology.

### Recycling Material

The material trimmed from the film, such as, side edges, contains both EVOH and non-organic cavitating agent. Post used film may be reclaimed as reclaimed material that contains both EVOH and non-organic cavitating agent. These materials can be used in the recycling step of the manufacturing process of this disclosure.

### Industrial Application

In some embodiments, the film made by a process of this disclosure may be used in flexible packaging and labeling applications.

Films according to the present disclosure may further be treated for its intended use such as by coating, printing, slitting, or other converting methods.

The present disclosure will be explained in more detail referring to Examples below without intention of restricting the scope of the present disclosure.

### Inventive Example and Comparative Example

The EVOH used in the inventive example and the comparative example was obtained from Kuraray Co. as Eval 176G.

Both the inventive example and the comparative example are five layers films made with a polypropylene core layer cavitated with PBT (the comparative example) or calcium carbonate (the inventive example) and an EVOH co-extruded layer. The comparative example and the inventive example were co-extruded 260° C. with 5 separate extruders having a total output of about 2200 kg/hour. The co-extrudates were quenched with a chill roll and a water bath, both set to 45° C., and then biaxially stretched 4.7 times in the MD and 9.0 times in the TD. The side edges of the oriented film were trimmed and recycle in-line back to the extruder.

Using PBT as cavitating agent, the film produced has uneven thickness and process control problems. The film of the comparative example splits and has defects, such as, void and gel spot. The average thickness variation measured by the orientation line gauge scanner was increasing to an unacceptable 6% or more after only 12 hours of production, requiring equipment expensive shut down for cleaning, resulting in poor production efficiencies, high quality rejects, material downgrading in subsequent processes (such as coating and slitting), and high product cost.

Using calcium carbonate as cavitating agent, the film produced has uniform thickness and no process control problems. The film of the inventive example has no split and no defects attributable to the cavitating agent with excellent profile control and only typical process upsets. The average thickness variation measured by the orientation line gauge scanner was less than 3% even after more than 24 hours of production resulting in good production efficiencies, high quality product, and low product cost.

Re-processed scrap material and trim material generated from the production of EVOH and PBT containing film was recycled in the inventive example at up to 2.4% EVOH in the core layer of the film structure without splits or film quality defects such as voids or gels. In the comparative example, combining EVOH and PBT in the core layer of the film at 0.2% EVOH in the core layer caused film quality defects such as unacceptable film flatness uniformity.

Replacing the PBT cavitating agent with a non-organic cavitating agent, such as CaCO₃ solves the recycle process upset problem and allows the process to include in-line trim recycle containing the EVOH and non-organic cavitating agent.

Thus, while there have been described what are presently believed to be the preferred embodiments of the invention, those skilled in the art will realize that various changes and modifications may be made to the invention without departing from the spirit of such invention. All such changes and modifications which fall within the scope of the invention are therefore intended to be claimed.

1. A process for producing multilayer film, said process comprising:
(a) co-extruding:
(i) a first polymeric composition having a non-organic cavitating agent;
(ii) a second polymeric composition having EVOH to form a multilayer sheet; and
(b) orienting said multilayer sheet in MD, TD or both to form said multilayer film, wherein the first polymeric composition and/or the second polymeric composition further comprises recycled polymeric composition having EVOH and the non-organic cavitating agent.

2. The process of claim 1, wherein said non-organic cavitating agent is calcium carbonate.

3. The process of claim 1, wherein said first polymeric composition comprises polypropylene.

4. The process of claim 1, wherein said recycled polymeric composition having EVOH comprises trimmed edges of said multilayer film, reclaimed EVOH containing material, repelletized EVOH containing material, or any combination thereof.

5. The process of claim 1, further comprising a step of in-line trimming edges of said multilayer film.

6. The process of claim 5, further comprising a step of recycling trimmed edges to the co-extruding step.

7. The process of claim 1, wherein said first polymeric composition comprises at least 0.5 wt. % of EVOH from said recycled polymeric composition.

8. The process of claim 1, wherein said first polymeric composition comprises at least 1 wt. % of EVOH from said recycled polymeric composition.

9. The process of claim 1, wherein said first polymeric composition comprises less than 2.4 wt. % of EVOH from said recycled polymeric composition.

10. A film made by claim 1.
